(19) United States
(12) Patent Application Publication
(10) Pub. No.: US 2025/0382168 A1
(43) Pub. Date: Dec. 18, 2025

(54) METHOD AND APPARATUS FOR FILLING AND CLOSING CONTAINERS

(71) Applicant: KRONES AG, Neutraubling (DE)

(72) Inventors: Thomas KONRAD, Regensburg (DE); Holger MUELLER, Pentling (DE); Stefan POESCHL, Sinzing (DE); Bastian KOERNER, Kastl (DE); Florian HABERSETZER, Regensburg (DE); Christian JANKER, Leuchtenberg (DE); Christian SCHOEN, Sulzbach-Rosenberg (DE); Matthias STUBENHOFER, Falkenstein (DE)

(21) Appl. No.: 19/236,470

(22) Filed: Jun. 12, 2025

(30) Foreign Application Priority Data
Jun. 13, 2024 (DE) 10 2024 116 555.3

(51) Int. Cl. B67C 7/00; B67C 3/26; B67C 3/28

(52) U.S. Cl. CPC B67C 7/00; B67C 3/26; B67C 3/283

(57) ABSTRACT

The invention relates to, among other things, a method for filling and closing containers. At least an upper portion of a container (B) is positioned in a treatment chamber. The container is filled with a carbonated filling material via a filling member up to a gas volume in a head space of the container. The filling member is removed from the container mouth after filling, wherein a pressure in the treatment chamber is greater than a saturation pressure of the carbonated filling material. The pressure in the treatment chamber is reduced below the saturation pressure of the carbonated filling material, thereby causing foaming of the carbonated filling material in the head space of the filled container, which forces the gas volume out of the head space. The container is closed via a closing member.

### CROSS-REFERENCE TO RELATED APPLICATIONS

This application claims the benefit under 35 U.S.C. § 119(a) of German Patent Application No. DE 10 2024 116 555.3, filed Jun. 13, 2024, entitled METHOD AND APPARATUS FOR FILLING AND CLOSING CONTAINERS, and whose entire disclosure is incorporated by reference herein.

### TECHNICAL FIELD

The invention relates to a method for filling and closing containers. The invention further relates to an apparatus, preferably a rotary apparatus, for filling and closing containers.

### TECHNICAL BACKGROUND

EP 2 937 310 A2 relates to a method for filling a container with a filling product in a beverage filling plant, comprising providing the filling product under an overpressure and evacuating the container to be filled to achieve a negative pressure, wherein the filling product under an overpressure is introduced into the container under a negative pressure. After the filling product has been introduced, the filled container is pressurized with a pressurizing gas in a chamber to prevent the filling product from overfoaming before the container is closed.

In order to implement this technique, it is necessary that the chamber surrounding the container neck is low in oxygen. For this purpose, it can for example be evacuated and flushed with process gas (CO2, N2). This process may be necessary several times, in order to keep oxygen absorption in the filling material of the container low before closing and to comply with required specifications. As the process is repeated, the vacuum and process gas requirements increase. These consumption levels are in strong competition with other filling systems and must, of course, be kept low from an economic and ecological point of view.

Leaks due to wear of chamber seals also lead to a further increased demand for vacuum and process gases, accompanied by a gradual deterioration in product quality, which can go unnoticed during the filling process. A permanently stable process is almost impossible.

The invention is based on the object of developing an improved technique for filling and closing a container, with which oxygen absorption by the filled filling material can be kept as low as possible and the above-mentioned disadvantages can be overcome at least in part.

### SUMMARY OF THE INVENTION

The object is achieved by the features of the independent claims. Advantageous developments are specified in the dependent claims and the description.

One aspect relates to a method for filling and closing containers (e.g., via an apparatus as disclosed herein). The method comprises (e.g., controlled by a control device):
positioning at least an upper portion of a container in a (e.g., evacuable, flushable and/or pre-pressurizable) treatment chamber (e.g., via a lifting device), wherein preferably at least the upper portion of the container is received in a sealed manner in the treatment chamber;
filling the container, positioned at least in portions in the treatment chamber, with a carbonated (carbonic acid-containing) filling material (e.g., under overpressure) via a filling member, wherein the filling member and a container mouth of the container are pressed against one another in a sealed manner and the container is filled with the carbonated filling material up to a gas volume in a head space of the container;
removing (e.g., moving away) the filling member from the container mouth after the filling (e.g., via a drive unit of the filling member), wherein a pressure in the treatment chamber is greater than a saturation pressure of the carbonated filling material;
reducing the pressure in the treatment chamber below the saturation pressure of the carbonated filling material, thereby causing foaming of the carbonated filling material in the head space of the filled container, which forces the gas volume out of the head space; and
closing the container, positioned at least in portions in the treatment chamber, via a closing member after the removing the filling member and the reducing the pressure.

The proposed technique is based on deliberately causing the carbonated filling material in the container to foam, in order to force/expel the gas volume containing residual oxygen out of the head space. This can advantageously significantly reduce the oxygen absorption by the filled filling product. This advantageously leads to a greatly improved filling material quality in the container. The advantage here is that the need for process gas (pre-pressurizing gas) is reduced. Advantageously, a necessary compensation (increased process gas consumption) due to possible leaks in the chamber is not necessary, since the influence of the chamber atmosphere can be neglected due to foaming. The filling process thus becomes more stable over the entire life cycle of the filling-closing apparatus.

In one embodiment, the pressure in the treatment chamber is reduced below the saturation pressure of the carbonated filling material after the filling member has been removed. This can advantageously prevent premature foaming and thus overfoaming of the filling material, and thus improve process reliability.

In a further embodiment, closing takes place directly after the gas volume has been completely or substantially completely forced out of the head space, and/or the closing takes place at a time when the foamed filling material reaches the container mouth or protrudes beyond the container mouth without overfoaming or without overfoaming significantly. This can advantageously ensure that as little residual oxygen as possible remains in the head space of the container. In addition, contamination of the treatment chamber by overfoaming filling material can advantageously be prevented, and the shortest possible total treatment time can be achieved.

In one embodiment, the pressure in the treatment chamber is reduced below the saturation pressure for ≥10 ms or ≥20 ms before closing takes place. Alternatively or additionally, the pressure in the treatment chamber may be reduced below the saturation pressure for ≤300 ms or ≤200 ms before closing takes place. As already mentioned, this can advantageously achieve as little residual oxygen as possible remaining in the head space of the container. In addition, as already mentioned, advantageously the shortest possible total treatment time can be achieved.

In a further embodiment, a period of time for which the pressure in the treatment chamber is reduced below the saturation pressure before the container is closed is adjustable (e.g., via a user interface) for influencing the foaming, preferably between 10 ms and 300 ms, preferably between 20 ms and 200 ms. Alternatively or additionally, a pressure difference between the pressure in the treatment chamber upon removal of the filling member, and the reduced pressure in the treatment chamber below the saturation pressure, preferably after removal of the filling member, can be adjusted in order to influence the foaming (e.g., via a user interface), preferably between 0.5 bar and 2 bar. This can advantageously be used to adjust the foaming behavior of the carbonated filling material in order to ultimately create a foaming behavior that leads to foaming of the filling material up to the container mouth shortly before closing, so that ultimately as little residual oxygen as possible remains in the head space of the container.

In one variant, the reducing the pressure in the treatment chamber comprises discharging a pressurizing gas from the treatment chamber via the filling member removed from the container mouth, preferably via a pressurizing and/or flushing gas channel of the filling member. Thus, advantageously, existing equipment technology can be used to reduce the pressure in the treatment chamber.

In a further variant, the method further comprises at least in part reusing the discharged pressurizing gas as flushing gas when flushing a subsequent container via the filling member. Advantageously, some of the pressurizing gas can thus be recovered/reused, which preferably significantly reduces the process gas consumption of the method.

In a further embodiment, the method further comprises positioning the closing member in a standby position directly above the container mouth of the container positioned at least in portions in the treatment chamber after removal of the filling member and before and/or during reduction of the pressure in the treatment chamber below the saturation pressure of the carbonated filling material. On the one hand, this can advantageously provide a throttle for the gas volume escaping from the head space. On the other hand, it can advantageously be made possible that the container can be closed quickly at a desired time, in order to close the container when the entire gas volume has been pushed out and before the foamed filling material overfoams.

In one embodiment, in the standby position there is a distance between the closing member and the container mouth which is preferably ≥0.5 mm and/or ≤3 mm, particularly preferably around 1.5 mm. This advantageously allows a particularly favorable throttling effect to be achieved for the gas volume forced out of the head space, and also ensures that the container can be closed quickly at the desired time.

In a further embodiment, in the standby position there is an annular gap between the closing member and the container mouth, which preferably acts as a (e.g., adjustable) throttle for the gas volume forced out of the head space. This advantageously allows the discharge characteristics of the gas volume and thus also the foaming of the filling material to be influenced as desired in order to further improve the process.

In one variant, the distance is adjustable by adjusting the standby position to influence foaming (e.g., via a user interface), preferably between 0.5 mm and 3 mm. Alternatively or additionally, the size of the annular gap can be adjustable by adjusting the standby position to influence foaming (e.g., via a user interface). This can advantageously be used to adjust the foaming behavior of the carbonated filling material in order to ultimately create a foaming behavior that leads to foaming of the filling material up to the container mouth shortly before closing, so that ultimately as little residual oxygen as possible remains in the head space of the container.

In a further variant, the method further comprises:
evacuating the container, positioned at least in portions in the treatment chamber, via the filling member before filling, wherein the filling member and the container mouth are pressed against one another in a sealed manner during the evacuation; and optionally
flushing the container, positioned at least in portions in the treatment chamber, after evacuation and before filling, wherein the filling member and the container mouth are pressed against one another in a sealed manner during flushing; and preferably
re-evacuating the container, positioned at least in portions in the treatment chamber, via the filling member after flushing and, preferably immediately before filling, wherein the filling member and the container mouth are pressed against one another in a sealed manner during the re-evacuating.

Advantageously, the filling process can thus be further improved and, in particular, the filling speed can be increased and the residual oxygen content in the filled filling material can be reduced.

In a further variant, the method further comprises:
pre-pressurizing the treatment chamber to a pressure above the saturation pressure of the carbonated filling material before removing the filling member from the container mouth; and optionally
evacuating the treatment chamber before pre-pressurizing.

This can advantageously achieve that the carbonated filling material in the container does not immediately foam up when the filling member is removed. Instead, foaming can be delayed by selecting the time for reducing the pressure to a desired point in time, e.g., until the closing member is in the standby position for achieving the desired throttling effect.

A further aspect relates to an apparatus, preferably a rotary apparatus, for filling and closing containers. The apparatus has at least one treatment station comprising a (e.g., movable) filling member, a (e.g., movable) closing member and a (e.g., evacuable and/or pre-pressurizable) treatment chamber in which at least an upper portion of a container can be positioned, preferably received in a sealed manner. The apparatus further comprises a control device configured to operate the apparatus according to a method disclosed herein. Advantageously, the apparatus can achieve the same advantages as already described with reference to the method.

In one embodiment, the closing member comprises a closing element for closing the container, wherein the closing element is preferably configured to receive a crown cap for closing the container. The closing member may further comprise a, preferably electric, drive unit for (e.g., linearly) moving the closing element for closing the container, wherein the drive unit is preferably an electric servo drive unit.

In a further embodiment, the treatment chamber is sealable, preferably on the top side via the closing member and/or on the bottom side via a preferably inflatable seal to the container, preferably the container neck.

A further aspect of the present disclosure relates to a container treatment plant (e.g., for controlling the temperature, producing, cleaning, coating, testing, filling, closing, pasteurizing, labeling, printing, marking, laser marking, and/or packaging containers for liquid or pasty media, preferably beverages, liquid foods or products from the pharmaceutical or healthcare industry). The container processing plant can comprise the apparatus as disclosed herein. The container processing plant can, for example, be a beverage filling plant.

For example, the containers can be realized as bottles, cans, canisters, cartons, vials, tubes, etc.

Preferably, the term “control device” can refer to an electronic system (e.g., embodied as a driver circuit or with microprocessor(s) and data memory) and/or a mechanical, pneumatic, and/or hydraulic controller, which can take over open-loop control tasks and/or closed-loop control tasks and/or processing tasks, depending on the configuration. Although the term “control” is used herein, this can also comprise or be understood as “closed-loop control” or “control with feedback” and/or “processing” as appropriate. The control device can, for example, be a central control device or have a plurality of decentralized or distributed control units.

The preferred embodiments and features of the invention described above can be combined with one another as desired.

### BRIEF DESCRIPTION OF THE FIGURES

Further details and advantages of the invention are described below with reference to the accompanying drawings, in which:

FIG. 1 is a schematic representation of an apparatus for filling and closing containers according to an embodiment; and

FIGS. 2 to 6 show steps of a method for filling and closing containers according to an embodiment.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

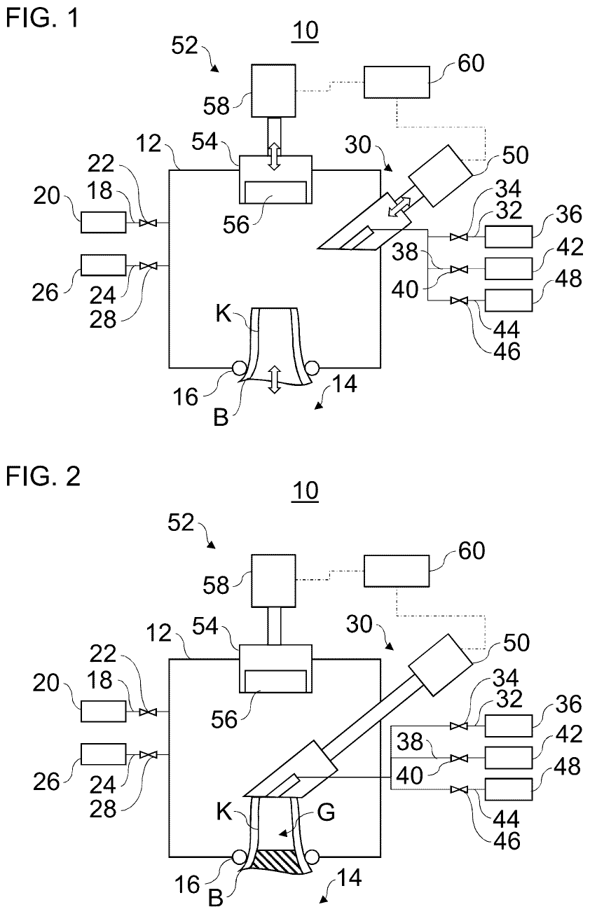

FIG. 1 shows an apparatus 10 for filling and closing containers B. Preferably, the apparatus 10 is an integrated filling-closing apparatus, preferably in a rotary configuration.

The apparatus 10 can for example be included in a container processing plant, e.g., a beverage filling plant. For example, the apparatus 10 can be arranged in the container processing plant downstream (relative to the container) of a cleaning apparatus for cleaning the containers B. For example, the apparatus 10 can be arranged in the container processing plant upstream (relative to the container) of a labeling apparatus for labeling the containers B.

The apparatus 10 has a treatment chamber 12, a filling member 30, a closing member 52, and a control device 60. Preferably, the apparatus 10 has a plurality of treatment stations, each with a treatment chamber 12, a filling member 30 and a closing member 52 for the simultaneous or temporally overlapping treatment (filling and closing) of a plurality of containers B. The apparatus 10 can preferably be configured as a rotary apparatus. For example, the stations can be arranged distributed around a circumference of a carousel of the rotary apparatus.

Preferably, the treatment station can be moved during filling and closing of the container B for transporting the container B from an inlet to an outlet of the apparatus 10, e.g., on a partial circle of the apparatus 10, of the device, configured by way of example as a rotary device.

At least an upper portion of the container B with its container mouth can be received in a sealed manner in the treatment chamber 12. The container B, which is at least in portions received in the treatment chamber 12, can be filled via the filling member 30 and closed via the closing member 52.

For example, the container B can be held via a container receptacle 14 (not shown in detail in FIG. 1). The container receptacle 14 may have a container holder for holding the container B. The container holder can, for example, be a container plate (a support plate) for supporting the container B at the base. The container B can stand on the container plate. Alternatively or additionally, the container holder can support the container B, for example, on its container body or container neck ring, for example as a container clamp.

Preferably, the container B can be moved by the container receptacle 14 in order to position at least the upper portion of the container B in the treatment chamber 14. For example, a lifting device can lift the container receptacle 14 together with the container B. The container B can be introduced into the treatment chamber 12 from below, at least in portions, via the lifting device. After treatment, the container B can be removed/moved downwards out of the treatment chamber 12 via the lifting device. The lifting device can be, for example, an electric, hydraulic or pneumatic lifting device.

For the treatment, the portion of the container B received in the treatment chamber 12 can be received in a sealed manner in the treatment chamber 12. For example, the treatment chamber 12 can be sealed at the top by the closing member 52. For example, the treatment chamber 12 can be sealed at the underside with respect to a container neck of the container B via a seal 16 (for example, a container neck seal). The seal 16 can, for example, take the form of an inflatable annular body that can be placed around a container neck of the container B.

It is possible that the treatment chamber 12 is, for example, evacuated, flushed and/or pre-pressurized.

The treatment chamber 12 can, for example, be connected to a vacuum source 20 via an evacuation channel 18. An evacuation valve 22 can be arranged in the evacuation channel 18 for selectively blocking or releasing the evacuation channel 18. For example, the control device 60 can operate the evacuation valve 22 to selectively assume an open position or a closed position. When the evacuation valve 22 is in an open position, gas can be suctioned from the treatment chamber 12 through the evacuation channel 18 towards the vacuum source 20. The treatment chamber 12 can thus be evacuated, e.g., to a pressure level below ambient pressure, e.g., to a negative pressure at an absolute pressure of 0.5 bar to 0.05 bar, preferably 0.3 bar to 0.1 bar, particularly preferably 0.1 bar.

The treatment chamber 12 can, for example, be connected to a pressurizing gas source 26 via a pressurizing gas channel 24. The pressurizing gas source 26 may, for example, be an inert gas source, e.g., a carbon dioxide source or a nitrogen source. A pressurizing gas valve 28 can be arranged in the pressurizing gas channel 24 for selectively blocking or releasing the pressurizing gas channel 24.

For example, the control device 60 can operate the pressurizing gas valve 28 to selectively assume an open position or a closed position. When the pressurizing gas valve 28 is in an open position, pressurizing gas, e.g., carbon dioxide (CO2) or nitrogen (N), can be supplied from the pressurizing gas source 26 through the pressurizing gas channel 24 to the treatment chamber 12. The treatment chamber 12 can thus be pre-pressurized. For example, the treatment chamber 12 can be pressurized with a pressurizing gas at an absolute pressure of 2 bar to 9 bar, preferably at an absolute pressure of 3.5 bar to 7 bar, particularly preferably at an absolute pressure of 3.8 bar to 5.5 bar.

The filling member 30 is configured to fill the container B which is received at least in portions in the treatment chamber 12. The filling member 30 can fill the container B with a carbonated (carbon dioxide-containing) liquid or pasty filling material.

The filling member 30 can fill the container B with a filling pressure (overpressure) that is greater than a saturation pressure of the carbonated filling material. For example, the filling material can be provided under an overpressure with an absolute pressure of 1 bar to 9 bar, preferably 2.5 bar to 6 bar, particularly preferably 2.8 bar to 3.3 bar, from a filling material source 36, and filled into the container B via the filling member 30.

For example, the filling member 30 can comprise a filling material channel 32 having a filling valve 34 for selectively releasing or blocking the filling material channel 32. The filling member 30 can be connected to a filling material source 36, preferably a filling material tank, via the filling material channel 32. The filling material source 36 can provide a carbonated filling material, e.g., beer, carbonated water, or another carbonated beverage. Preferably, the filling material source 36 can provide the carbonated filling material with the mentioned overpressure.

For example, the control device 60 can operate the filling valve 34 to selectively assume an open position or a closed position. Optionally, an open flow cross section of the filling valve 34 can be adjusted. When the filling valve 34 is in an open position, the carbonated filling material can be fed through the filling material channel 32 to an outlet of the filling member 30. The container B can thus be filled with the carbonated filling material.

For example, the filling member 30 may have an evacuation channel 38 with an evacuation valve 40 for selectively releasing or blocking the evacuation channel 38. The filling member 30 can be connected to a vacuum source 42 via the evacuation channel 38. The vacuum source 42 may be connected to the vacuum source 20 or may be formed as a common vacuum source. For example, the control device 60 can operate the evacuation valve 40 to selectively assume an open position or a closed position. When the evacuation valve 40 is in an open position, gas can be sucked from an outlet of the filling member 30 through the evacuation channel 38 towards the vacuum source 42. The container B can thus be evacuated, e.g., to a pressure level below ambient pressure.

For example, the filling member 30 may have a flushing gas channel 44 with a flushing gas valve 46 for selectively releasing or blocking the flushing gas channel 44. The filling member 30 can be connected to a flushing gas source 48 via the flushing gas channel 44. The flushing gas source 48 may, for example, be an inert gas source, e.g., a carbon dioxide source or a nitrogen source.

The flushing gas source 48 can be connected to the pressurizing gas source 26 or can be configured as a common pressurizing and/or flushing gas source. Preferably, the flushing gas channel 44 or the flushing gas source 48 is under a higher (absolute) pressure than the pressurizing gas channel 24 or the pressurizing gas source 26. For example, the flushing gas source 48/the flushing gas channel 44 has an absolute pressure of 0.5 bar to 4 bar, preferably an absolute pressure of 1.4 bar to 1.9 bar. For example, the pressurizing gas source 26/the pressurizing gas channel 84 has an absolute pressure of 2 bar to 11 bar, preferably an absolute pressure of 5 bar to 9 bar.

For example, the control device 60 can operate the flushing gas valve 46 to selectively assume an open position or a closed position. When the flushing gas valve 46 is in an open position, flushing gas, e.g., carbon dioxide (CO2) or nitrogen (N), can be supplied from the purge gas source 48 through the flushing gas channel 44 to an outlet of the filling member 30. The container B can thus be flushed.

The filling member 30 can be pressed against a container mouth of the container B in order to fill the container B. Preferably, the filling member 30 may have a drive unit 50. The drive unit 50 can move the filling member 30 in order to press it onto the container mouth and to release the container mouth. Preferably, the drive unit 50 can move an outlet of the filling member 30 within the treatment chamber 12, e.g., obliquely or horizontally.

The drive unit 50 can move the outlet of the filling member 30 in order to press it onto the container mouth, for example when a treatment by the filling member 30 is desired, such as evacuating, flushing, pre-pressurizing and/or filling. The drive unit 50 can move the outlet of the filling member 30 away from the container mouth, in order to make possible, for example, treatment of the container B by the closing member 52. The drive unit 50 can preferably move the filling member 30 along an axis which is inclined to a vertical axis of the apparatus 10 or the container B. The drive unit 50 can be, for example, an electrical, electromagnetic, pneumatic or hydraulic drive unit 50, e.g., controlled by the control device 60.

The closing member 52 can comprise a closing element 54 and a drive unit 58.

The closing element 54 is movable in order to be moved to the container B, received at least in portions in the treatment chamber 12, and for application of a closure 56 to the container B. Preferably, the closing element 54 is movable downwards and upwards in a vertical direction. In detail, the closing element 54 can be moved to a container mouth of the container B received at least in portions in the treatment chamber 12 and can then apply the closure 56 to the container mouth. It is possible for the closure 56 to be for example pressed, pushed or screwed onto the container B via the closing element 54.

The closure 56 that can be applied by the closing element 54 can be, for example, a lid, a cork, a crown cap or a screw cap. Particularly preferably, the closing element 54 is configured to close the container B with a closure 56 configured as a crown cap. The closing element 54 can, for example, have a closing head configured as a punch or attachment.

The drive unit 58 can be connected to the closing element 54 for driving the closing element 54 to move to and away from the container B. Preferably, in this case, the drive unit 58 can move the closing element 54 vertically, for example in a vertical direction downwards towards the container B and in a vertical direction upwards away from the container B. Depending on the configuration of the closure 56, however, for example rotational movements of the closing element 54 driven by the drive unit 58 are also possible. The drive unit 50 can be, for example, an electrical, electromagnetic, pneumatic or hydraulic drive unit 50, e.g., controlled by the control device 60.

A method for filling and closing a container B, preferably via the apparatus 10, e.g., controlled by the control device 60, is explained below with reference to FIGS. 2 to 6.

FIG. 2 shows that at least the upper portion of the container B is positioned/received in the treatment chamber 12. Preferably, the container B was introduced into the treatment chamber 12 from below by a lifting device (not shown in FIG. 2) and held in the container receptacle 14. Preferably, the seal 16 can seal between the treatment chamber 12 and the container B. For example, compressed air can be applied to the seal 16.

Preferably, the container B is filled with an overpressure by the filling member 30. Preferably, a negative pressure in container B before filling prevails.

The filling member 30 fills the container B, which is positioned at least in portions in the treatment chamber 12, with a carbonated filling material. In this case, the filling member 30 and the container mouth of the container B are pressed against one another in a sealed manner. Preferably, the drive unit 50 has moved the filling member 30 towards the container mouth of the container B for pressing it against the container mouth, and/or the container B has been moved from below via the lifting device (not shown in FIG. 2), against the extended filling member 30, in order to press the filling member 30 and the container mouth together.

The container B is filled with the carbonated filling material by the filling member 30 up to a gas volume G in the head space K of the container B adjacent to the container mouth. For filling, for example the control device 60 can operate the filling valve 34 to open. Carbonated filling material can flow from the filling material source 36 through the filling material channel 32 of the filling member 30 into the sealed, pressed container B.

Before filling container B, the container B may preferably be evacuated, flushed and evacuated again.

For example, the container B can be evacuated via the filling member 30, while the filling member 30 and the container mouth are pressed against one another in a sealed manner. For evacuation, for example the control device 60 can operate the evacuation valve 40 to open. Gas from the container B, pressed on in a sealed manner, can flow via the evacuation channel 38 to the vacuum source 42.

Preferably, the container B can be flushed via the filling member 30 after evacuation, while the filling member 30 and the container mouth are pressed against one another in a sealed manner. For flushing, for example the control device 60 can operate the flushing gas valve 46 to open. Flushing gas from the flushing gas source 48 can flow via the flushing gas channel 44 of the filling member 30 into the sealed, pressed-on container B.

Preferably, the container B can be evacuated again via the filling member 30 after flushing, while the filling member 30 and the container mouth are pressed against one another in a sealed manner. For re-evacuation, the control device 60 can, for example, operate the evacuation valve 40 to open. (Flushing) gas from the container B, pressed on in a sealed manner, can be sucked through the evacuation channel 38 to the vacuum source 42.

Accordingly, the carbonated filling material can preferably be filled into the (e.g., re-)evacuated container B during filling. In the (e.g., re-)evacuated container B, a negative pressure preferably prevails.

While the container B is received in the treatment chamber 12 in a sealed manner in portions, the treatment chamber 12 can be pre-pressurized to a pressure which is above a saturation pressure of the carbonated filling material.

For pre-pressurizing, for example the control device 60 can operate the pressurizing gas valve 28 to open. Pressurizing gas from the pressurizing gas source 26 can flow into the treatment chamber 12 via the pressurizing gas channel 24.

The pre-pressurization of the treatment chamber 12 takes place before the removal of the filling member 30 from the container mouth. For example, the treatment chamber 12 can be pressurized while the container B is evacuated, flushed, re-evacuated and/or filled.

Particularly preferably, the treatment chamber 12 is evacuated before pre-pressurizing. For evacuation, for example the control device 60 can operate the evacuation valve 22 to open. Gas from the treatment chamber 12 can be sucked through the evacuation channel 18 to the vacuum source 20.

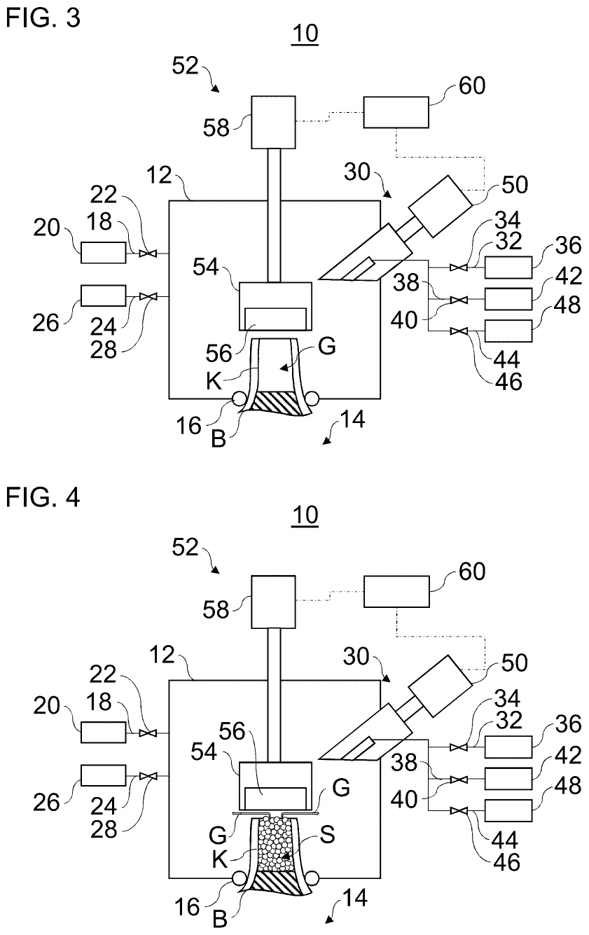

FIG. 3 shows that the filling member 30 is removed from the container mouth of the container B after filling. The filling member 30 can, for example, be moved away from the container mouth via the drive unit 50. In this case, a pressure can prevail in the treatment chamber 12 which is greater than a saturation pressure of the carbonated filling material in the container B. Accordingly, the filling material in container B does not foam up.

Preferably, the closing member 52 can be positioned in a standby position after the filling member 30 has been removed from the container mouth. For example, the closing element 54 can be moved by the drive unit 58 into the standby position. Preferably, the standby position may be directly above the container mouth of container B.

Preferably, in the standby position of the closing member 52, there is an annular gap between an underside of the closing member 52 and the container mouth.

For example, in the standby position, there may be a distance between the closing member 52 and the container mouth which is preferably ≥0.5 mm and/or ≤3 mm, particularly preferably around 1.5 mm. The distance can be measured, for example, between a lowest point of the closing member 52 or the closure 56 held thereby, and a highest point of the container mouth. Preferably, the distance is measured in a vertical direction.

Preferably, the distance or a size of the annular gap can be adjusted by adjusting/adapting the standby position. For example, the distance can be adjustable in a range between 0.5 mm and 3 mm. For example, the distance or size of the annular gap can be specified by a user input via a user interface of the apparatus 10.

FIG. 4 shows that a pressure in the treatment chamber 12 is reduced below the saturation pressure of the carbonated filling material in the container B. Preferably, the pressure is reduced after the filling member 30 has been removed from the container mouth and/or only after the closing member 52 or the closing element 54 has been positioned in the standby position.

The reduction of the pressure in the treatment chamber 12 below the saturation pressure of the carbonated filling material in the container B causes a pressure in the head space of the container B to also fall below the saturation pressure of the carbonated filling material. This causes the carbonated filling material in the container B to foam. The carbonic acid bound in the carbonated filling material in part separates from the liquid filling material and foams it up in the head space K of the container B. The foaming or the resulting foam S causes the gas volume G still containing residual oxygen to be forced/displaced out of the head space K into the treatment chamber 12.

Preferably, the annular gap between the closing member 52/closing element 54 and the container mouth acts as a throttle for the gas volume G forced out of the head space K by the foam S. As already mentioned, the throttle can be adjusted by adjusting the standby position of the closing member 52/closing element 54 or the distance to the container mouth. This allows the foaming, in particular the speed of foaming, to be adjusted as desired.

In order to reduce the pressure, for example the control device 60 can operate the pressurizing gas valve 28 to close and the flushing gas valve 46 to open. As a result, the pressurizing gas can be sucked out of the treatment chamber 12 through the flushing gas channel 44 of the filling member 30 and the pressure in the treatment chamber 12 can fall below the saturation pressure of the carbonated filling material in the container B. Preferably, the pressurizing gas can thus be discharged from the treatment chamber 12 via the flushing gas channel 44 of the filling member 30 removed from the container mouth. Preferably, this discharged pressurizing gas can be at least in part reused in the next container treatment cycle as flushing gas when rising a subsequent container B via the filling member 30.

It is also possible that the pressure in the treatment chamber 12 is reduced in an additional or alternative manner below the saturation pressure of the carbonated filling material. For example, the pressure in the treatment chamber 12 can be reduced by the control device 60 operating the pressurizing gas valve 28 to close and the evacuation valve 22 and/or 40 to open.

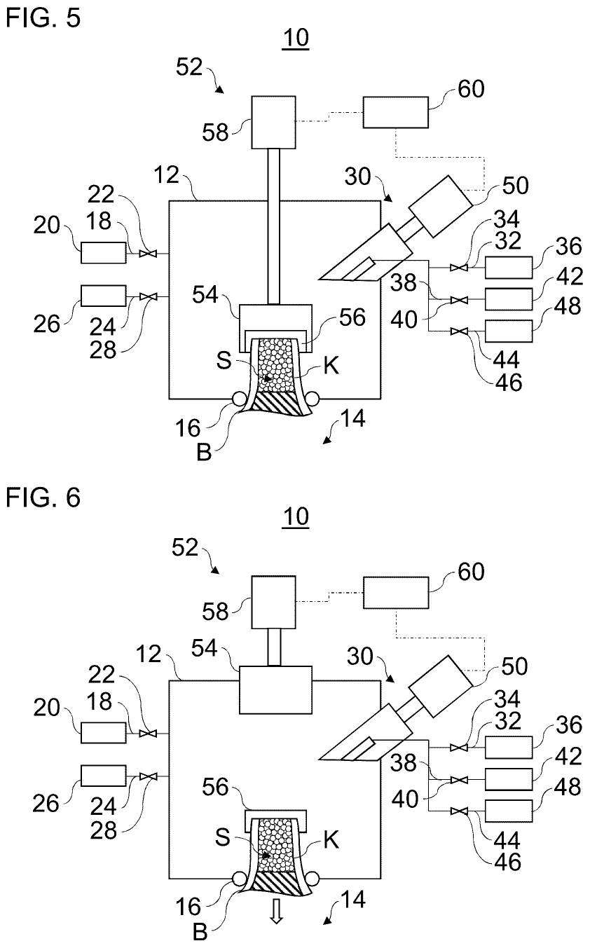

FIG. 5 shows that the container B, which is positioned at least in portions in the treatment chamber 12, is closed via the closing member 52 with a closure 56, preferably a crown cap. The closing takes place after the filling member 30 has been removed from the container mouth and after the pressure in the treatment chamber 12 has been reduced below the saturation pressure of the carbonated filling material (and thus the carbonated filling material has been foamed).

In order to close the container B, for example the closing member 52 can be lowered from the standby position into a closing position via the drive unit 58, and in doing so can apply the closure 56 to the container mouth, for example by pressing, pressing on or screwing on.

Preferably, the closure takes place immediately after the gas volume G has been completely or substantially completely forced out of the head space K (see FIG. 4). The closing can thus preferably take place at a time when the foamed filling material or the foam S reaches the container mouth or protrudes beyond the container mouth without the foamed filling material overfoaming or overfoaming significantly.

Preferably, the pressure in the treatment chamber 12 may be reduced below the saturation pressure for ≥10 ms or >20 ms before closing takes place. Preferably, the pressure in the treatment chamber 12 may be reduced below the saturation pressure for ≤300 ms or ≤200 ms before closing takes place.

As already mentioned, the foaming can be influenced by adjusting the standby position and thus setting the throttle for the forced-out gas volume G, so that, for example, undesired overfoaming before closing can be prevented. Alternatively or additionally, at least one other operating parameter of the apparatus 10 can be set to influence the foaming, for example via a user interface of the apparatus 10.

For example, a period of time for which the pressure in the treatment chamber 12 is reduced below the saturation pressure before the closing member 52 closes the container B can be set via a user interface. For example, the time duration can be set to a value between 10 ms and 300 ms, preferably between 20 ms and 200 ms.

For example, a pressure difference between the pressure in the treatment chamber 12 upon removal of the filling member 30 from the container mouth, and the reduced pressure in the treatment chamber 12 below the saturation pressure, preferably after removal of the filling member 30 from the container mouth, can be set via a user interface. According to the desired pressure difference, for example the control device 60 can adjust an operation of the sources 20, 26, 42 and/or 48 and/or an operation of the valves 22, 28, 40 and/or 46. Preferably, the pressure difference can be adjusted to a value between 0.5 bar and 2 bar.

FIG. 6 shows that the container B is closed with the closure 56. The container B can now be removed from the treatment chamber 12, for example via the lifting device. A new container B can then be received in a sealed manner, at least in portions, in the treatment chamber 12 for a further treatment cycle.

The invention is not limited to the preferred embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the sub-claims are also disclosed independently of all the features of independent claim 1. All ranges specified herein are to be understood as disclosed in such a way that all values falling within the relevant range are individually disclosed, e.g., also as the relevant preferred narrower outer limits of the relevant range.

### LIST OF REFERENCE SIGNS

10 apparatus for filling and closing
12 treatment chamber
14 container receptacle
16 seal
18 evacuation channel
20 vacuum source
22 evacuation valve
24 pressurizing gas channel
26 pressurizing gas source
28 pressurizing gas valve
30 filling member
32 filling material channel
34 filling valve
36 filling material source
38 evacuation channel
40 evacuation valve
42 vacuum source
44 flushing gas channel
46 flushing gas valve
48 flushing gas source
50 drive unit
52 closing member
54 closing element
56 closure
58 drive unit
60 control device
B container
G gas volume
K head space
S foam

What is claimed is:

1. A method for filling and closing containers, wherein the method comprises:
positioning at least an upper portion of a container in a treatment chamber;
filling the container, positioned at least in portions in the treatment chamber, with a carbonated filling material via a filling member, wherein the filling member and a container mouth of the container are pressed against one another in a sealed manner and the container is filled with the carbonated filling material up to a gas volume in a head space of the container;
removing the filling member from the container mouth after the filling, wherein a pressure in the treatment chamber is greater than a saturation pressure of the carbonated filling material;
reducing the pressure in the treatment chamber below the saturation pressure of the carbonated filling material, thereby causing foaming of the carbonated filling material in the head space of the filled container, which forces the gas volume out of the head space; and
closing the container, positioned at least in portions in the treatment chamber, via a closing member after the removing the filling member and the reducing the pressure.

2. The method according to claim 1, wherein:
the pressure in the treatment chamber is reduced below the saturation pressure of the carbonated filling material after the filling member has been removed.

3. The method according to claim 1, wherein at least one of the following is met:
the closing takes place immediately after the gas volume has been completely or substantially completely forced out of the head space; and
the closing takes place at a time at which the foamed filling material reaches the container mouth or protrudes beyond the container mouth without overfoaming or without overfoaming significantly.

4. The method according to claim 1, wherein at least one of the following is met:
the pressure in the treatment chamber is reduced below the saturation pressure for ≥10 ms or ≥20 ms before the closing takes place; and
the pressure in the treatment chamber is reduced below the saturation pressure for ≤300 ms or ≤200 ms before the closing takes place.

5. The method according to claim 1, wherein at least one of the following is met:
a period of time for which the pressure in the treatment chamber is reduced below the saturation pressure before the container is closed is adjustable to influence the foaming; and
a pressure difference between the pressure in the treatment chamber upon the removing the filling member and the reduced pressure in the treatment chamber below the saturation pressure is adjustable in order to influence the foaming.

6. The method according to claim 5, wherein at least one of:
the period of time is between 10 ms and 300 ms;
the pressure difference between the pressure in the treatment chamber upon the removing the filling member and the reduced pressure in the treatment chamber below the saturation pressure after the removing the filling member is adjustable in order to influence the foaming; and
the pressure difference between the pressure in the treatment chamber upon the removing the filling member and the reduced pressure in the treatment chamber below the saturation pressure is adjustable in order to influence the foaming between 0.5 bar and 2 bar.

7. The method according to claim 1, wherein the reducing the pressure in the treatment chamber comprises:
discharging a pressurizing gas from the treatment chamber via the filling member removed from the container mouth.

8. The method according to claim 7, wherein the discharging is via at least one of a pressurizing and flushing gas channel of the filling member.

9. The method according to claim 7, further comprising:
at least in part reusing the discharged pressurizing gas as flushing gas when flushing a subsequent container via the filling member.

10. The method according to claim 1, further comprising:
positioning the closing member in a standby position directly above the container mouth of the container positioned at least in portions in the treatment chamber after the removing the filling member and at least one of before and during the reducing the pressure in the treatment chamber below the saturation pressure of the carbonated filling material.

11. The method according to claim 10, wherein:
in the standby position there is a distance between the closing member and the container mouth.

12. The method according to claim 11, wherein:
in the standby position, there is an annular gap between the closing member and the container mouth.

13. The method according to claim 12, wherein at least one of the following is met:
the distance is adjustable by adjusting the standby position to influence the foaming; and
a size of the annular gap is adjustable by adjusting the standby position to influence the foaming.

14. The method according to claim 10, wherein at least one of:
in the standby position there is a distance between the closing member and the container mouth that is between 0.5 mm and 3 mm;
in the standby position there is an annular gap between the closing member and the container mouth, which acts as a throttle for the gas volume forced out of the head space; and
in the standby position the distance between the closing member and the container mouth is adjustable by adjusting the standby position to between 0.5 mm and 3 mm.

15. The method according to claim 1, further comprising:
evacuating the container, positioned at least in portions in the treatment chamber, via the filling member before the filling, wherein the filling member and the container mouth are pressed against one another in a sealed manner during the evacuating.

16. The method according to claim 15, further comprising at least one of:
flushing the container positioned at least in portions in the treatment chamber, after the evacuating and before the filling, wherein the filling member and the container mouth are pressed against one another in a sealed manner during the flushing;
re-evacuating the container positioned at least in portions in the treatment chamber via the filling member after the flushing, wherein the filling member and the container mouth are pressed against one another in a sealed manner during the re-evacuating;
re-evacuating the container positioned at least in portions in the treatment chamber via the filling member immediately before the filling, wherein the filling member and the container mouth are pressed against one another in a sealed manner during the re-evacuating; and
after the evacuating the treatment chamber, pre-pressurizing the treatment chamber to a pressure above the saturation pressure of the carbonated filling material before the removing the filling member from the container mouth.

17. The method according to claim 1, further comprising:
pre-pressurizing the treatment chamber to a pressure above the saturation pressure of the carbonated filling material before the removing the filling member from the container mouth.

18. An apparatus for filling and closing containers (B), wherein the apparatus comprises:
at least one treatment station comprising a filling member, a closing member and a treatment chamber in which at least an upper portion of a container can be positioned; and
a control device configured to operate the apparatus according to the method of claim 1.

19. The apparatus according to claim 18, wherein at least one of the following is fulfilled:
the closing member has a closing element for closing the container, and a drive unit for moving the closing element for closing the container; and
the treatment chamber is sealable to the container.

20. The apparatus according to claim 18, wherein at least one of:
the apparatus is a rotary apparatus;
the upper portion of the container is received in a sealed manner in the at least one treatment station;
the closing member has a closing element for closing the container, wherein the closing element is configured to receive a crown cap for closing the container, and a drive unit for moving the closing element for closing the container;
the closing member has the closing element for closing the container, and an electric drive unit for moving the closing element for closing the container;
the closing member has the closing element for closing the container, and an electric servo drive unit for moving the closing element for closing the container;
the treatment chamber is sealable at least one of on a top side via the closing member and on a bottom side via a seal to the container;
the treatment chamber is sealable on a bottom side via an inflatable seal to the container; and
the treatment chamber is sealable to the container neck.
